(19) United States
(12) Patent Application Publication
(10) Pub. No.: US 2024/0004985 A1
(43) Pub. Date: Jan. 4, 2024

(54) METHOD FOR NETWORK PROVISIONING WITHIN A WORKSPACE

(71) Applicant: VergeSense, Inc., Mountain View, CA (US)

(72) Inventors: Frank Agius, Mountain View, CA (US); Yuri Pisarevich, Mountain View, CA (US); Marine Dunoguier, Mountain View, CA (US)

(21) Appl. No.: 18/216,519

(22) Filed: Jun. 29, 2023

Related U.S. Application Data
(60) Provisional application No. 63/357,608, filed on Jun. 30, 2022.

(51) Int. Cl. G06F 21/44

(52) U.S. Cl. CPC G06F 21/44

(57) ABSTRACT

One variation of a method includes, at an external memory drive: initiating a wireless communication protocol with a sensor block; downloading a first key to the sensor block, the first key containing a wireless network setting associated with the workspace; retrieving a unique identifier assigned to the sensor block; and, in response to receiving confirmation of the sensor block connected to the wireless network setting, writing the unique identifier to a list of unique identifiers corresponding to a population of sensor blocks and downloading the list of unique identifiers to a computing device. This variation of the method also includes, at the computing device: accessing an activation status list of sensor blocks connected to the wireless network within the workspace; characterizing a difference between the list of unique identifiers and the activation status list of sensor blocks; and generating a notification to investigate the difference.

### CROSS-REFERENCE TO RELATED APPLICATIONS

This application claims the benefit of U.S. Provisional Application No. 63/357,608, filed on 30 Jun. 2022, which is incorporated in its entirety by this reference.

This application is related to U.S. patent application Ser. No. 15/973,445, filed on 7 May 2018, and U.S. patent application Ser. No. 16/191,115, filed on 14 Nov. 2018, both of which are incorporated in their entirety by this reference.

### TECHNICAL FIELD

This invention relates generally to the field of workplace monitoring and more specifically to a new and useful method for network provisioning within a workspace in the field of workplace monitoring.

### BRIEF DESCRIPTION OF THE FIGURES

FIG. 1 is a flowchart representation of a method;

FIGS. 2A and 2B are a flowchart representation of one variation of the method; and

FIG. 3 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

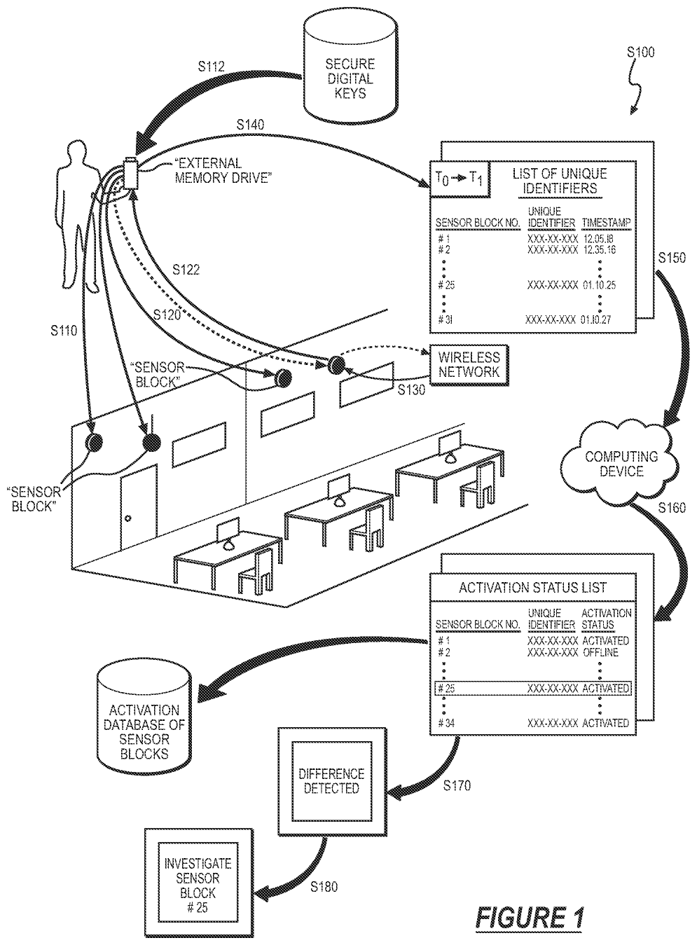

As shown in FIG. 1, a method S100 for network provisioning within a workspace includes, at a first sensor block deployed in the workspace and in response to detecting a first insertion of an external memory drive: initiating a wireless communication protocol with the external memory drive in Block Silo; receiving a first digital key from the external memory drive in Block S120; accessing a first wireless network setting associated with the workspace from the external memory drive based on the first digital key; and uploading a first unique identifier assigned to the first sensor block to the external memory drive in Block S122. The method S100 also includes, at the first sensor block, connecting to a wireless network within the workspace via the first wireless network setting in Block S130.

The method S100 further includes, at the external memory drive: writing the first unique identifier to a list of unique identifiers corresponding to a population of sensor blocks including the first sensor block and deployed throughout the workspace in Block S140; and downloading the list of unique identifiers to a computing device in Block S150.

The method S100 also includes, at the computing device: accessing an activation status list of sensor blocks connected to the wireless network within the workspace in Block S160; characterizing a difference between the list of unique identifiers and the activation status list of sensor blocks in Block S170; and generating a notification for a user to investigate the difference between the list of unique identifiers and the activation status list of sensor blocks connected to the wireless network within the workspace in Block S180.

### 1.1 Variation: External Memory Drive+Computing Device

One variation of the method S100 includes, at an external memory drive: initiating a wireless communication protocol with a first sensor block deployed in the workspace in Block Silo; downloading a first key to the first sensor block, the first key containing a wireless network setting associated with the workspace in Block S120; and retrieving a first unique identifier assigned to the first sensor block in Block S122. The method S100 also includes, in response to receiving confirmation of the first sensor block connected to the wireless network setting from a computing device: writing the first unique identifier to a list of unique identifiers corresponding to a population of sensor blocks including the first sensor block and deployed throughout the workspace in Block S140; and downloading the list of unique identifiers to a computing device in Block S150.

This variation of the method S100 further includes, at the computing device: accessing an activation status list of sensor blocks connected to the wireless network within the workspace in Block S160; characterizing a difference between the list of unique identifiers and the activation status list of sensor blocks in Block S170; and generating a notification to investigate the difference between the list of unique identifiers and the activation status list of sensor blocks connected to the network within the workspace in Block S180.

### 1.2 Variation: Sensor Block+External Memory Drive

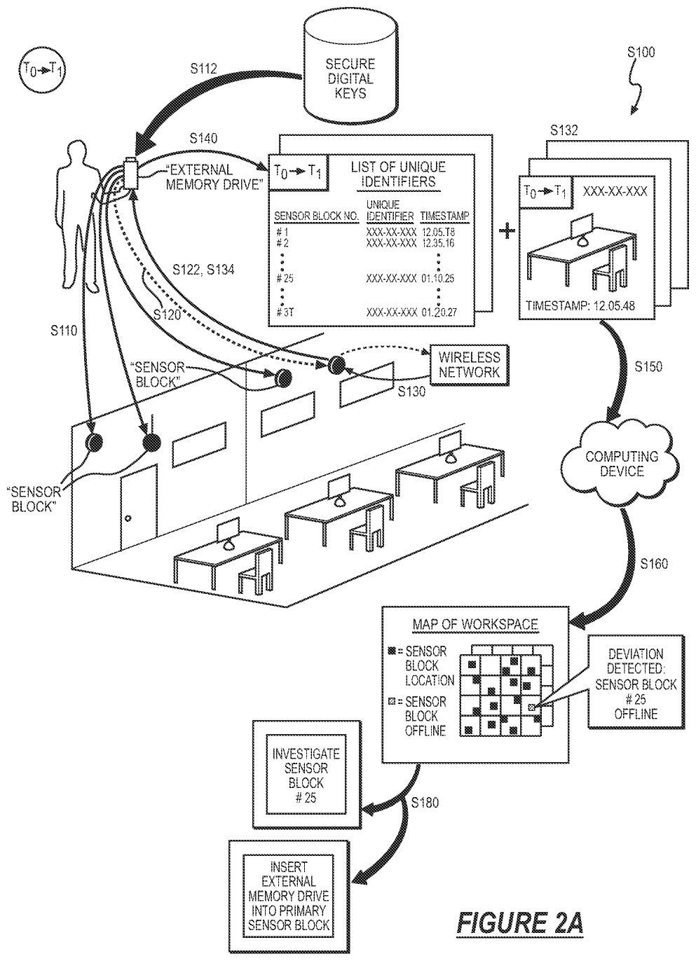

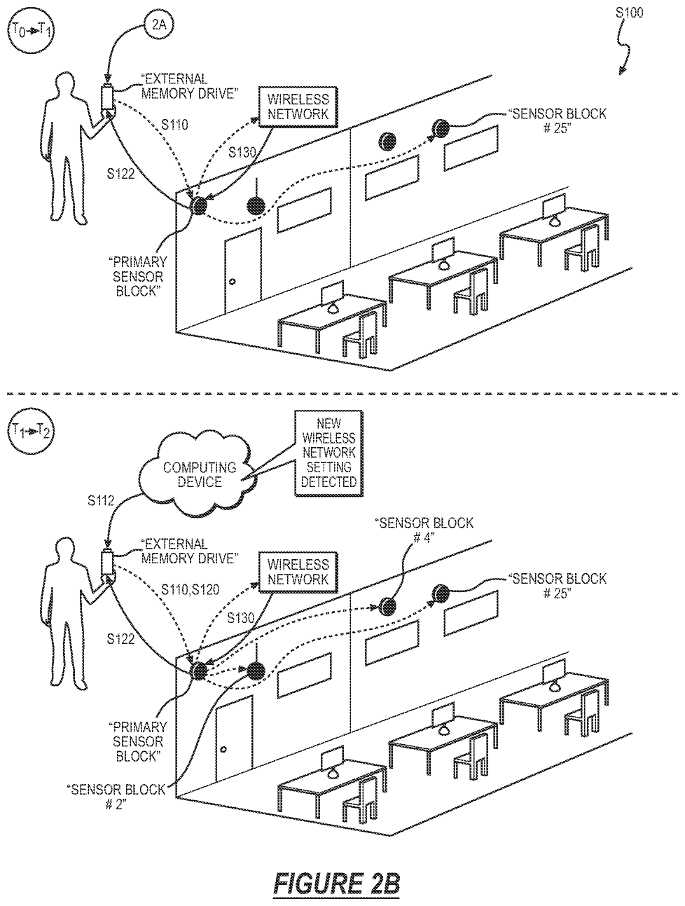

As shown in FIG. 2A, one variation of the method S100 includes, at a first sensor block deployed in the workspace and in response to detecting a first insertion of an external memory drive: initiating a wireless communication protocol with the external memory drive in Block Silo; receiving a first digital key from the external memory drive in Block S120; accessing a first wireless network setting associated with the workspace from the external memory drive based on the first digital key; and uploading a first unique identifier assigned to the first sensor block to the external memory drive in Block S122. The method S100 also includes at the first sensor block: connecting to a wireless network within the workspace via the first wireless network setting in Block S130; accessing a first sequence of images captured at an optical sensor arranged in the first sensor block; annotating the first sequence of images with a corresponding timestamp and the first unique identifier assigned to the first sensor block in Block S132; and, in response to detecting a second insertion of the external memory drive, uploading the first sequence of images to the external memory drive in Block S134.

This variation of the method S100 further includes, at the external memory drive: writing the first unique identifier to a list of unique identifiers corresponding to a population of sensor blocks including the first sensor block and deployed throughout the workspace in Block S140; and downloading the list of unique identifiers and the first sequence of images to a computing device for verification of activation of the first sensor block in Block S150.

### 2. Applications

Generally, Blocks of the method S100 can be executed by a population of sensor blocks—in a (mesh) network of sensor blocks—arranged throughout a workspace (e.g., an office, a conference room, a lounge, a reception lobby) in conjunction with a local gateway, a computing device (e.g., a computer system), and/or an external memory drive (e.g., a universal serial bus flash drive or USB stick): to securely unlock and activate sensor blocks in the workspace; to decrypt images captured on each sensor block; to monitor activation and deployment of each sensor block in the workspace by annotating non-optical data for compilation into a list of locally-activated sensor blocks; to generate a composite image and/or a map of the workspace representing locations of the population of sensor blocks; and to prevent unauthorized access, modification, deletion, and/or theft of data stored in each sensor block.

The method S100 is described herein as executed by each sensor block following installation and activation within the workspace: to capture encrypted (or “anonymized”) images; to establish network connectivity with a wireless network setting of the workspace; to update and/or revert network settings of each sensor block; to decrypt images based on a secure digital key (or “credentials”) stored in memory of the external memory drive; to offload images to the external memory drive, local gateway, or computer system; to upload a unique identifier (e.g., a UUID, MAC address, IP address, or other wireless address, etc.) to the external memory drive for writing a locally-activated list of unique identifiers; to annotate data; and/or to transmit these annotated data to the computer system or local gateway to access an activation status list of sensor blocks connected to the wireless network within the workspace.

The computer system can: compare the locally-activated list of unique identifiers to the activation status list (e.g., an activation database of sensor blocks); and generate notifications in response to detecting inaccuracies between the locally-activated list of unique identifiers and the activation status list. Furthermore, the computer system can selectively trigger a prompt for the user to investigate certain sensor blocks—identified as offline—deployed throughout the facility, thereby enabling the user to achieve accurate and reliable sensor block activation (e.g., all sensor blocks activated), avoid cloud computer network connectivity errors, and avoid infrastructure errors at the time of installation (or “activation”) of the sensor blocks and during subsequent computer network updates. The computer system can further receive an image and/or a sequence of images from each sensor block and aggregated these images into a composite image and/or a map of the workspace annotated with the locally-activated list of unique identifiers. The computer system can also project the activation status list of sensor blocks onto the map of the workspace, highlight regions of the map exhibiting a deviation, and serve a notification and the highlighted map to a user (e.g., an administrator, manager, or installer affiliated with the workspace).

The external memory drive can be configured with a pre-installed or a locally installed secure digital key and/or a set of secure digital keys that match unique identifiers (e.g., a UUID, MAC address, IP address, or other wireless address, etc.) pertaining to each sensor block to securely unlock and activate each sensor block during a setup period (e.g., installation period, deployment period). The external memory drive can also transfer a wireless network setting to each sensor block during the setup period. Furthermore, the external memory drive can store a decrypted image and/or a sequence of decrypted images captured by each sensor block in memory. Thus, the external memory drive provides security measures—in addition to the encrypted images captured at each sensor block—as a high-fidelity network hardware interface that can unlock, access, and/or activate a sensor block that matches the secure digital key stored in memory of the external memory drive.

The method S100 is described herein as executed by a sensor block in conjunction with a computer system and/or local gateway, and an external memory drive to securely unlock, activate, and access the stored data of each sensor block—while preventing unauthorized access, modification, deletion, and/or theft of these stored data—within a workspace such as an office or a conference room. However, Blocks of the method S100 can be similarly executed to securely unlock, activate, and access the stored data of each sensor block within an industrial, educational, municipal, or other setting.

### 3. Sensor Block

A sensor block can include: an optical sensor defining a field of view; a motion sensor configured to detect motion in or near the field of view of the optical sensor; a processor configured to extract data from images recorded by the optical sensor; a wireless communication module configured to wirelessly transmit data extracted from images; a battery configured to power the optical sensor, the processor, and the wireless communication module over an extended duration of time (e.g., one year, five years); and an housing configured to contain the optical sensor, the motion sensor, the processor, the wireless communication module, and the battery and configured to mount to a surface within the field of view of the optical sensor intersecting an area of interest within the facility (e.g., a conference table within a conference room, a cluster of agile desks in an agile work environment).

The optical sensor can include: a color camera configured to record and output 2D color images; and/or a depth camera configured to record and output 2D depth images or 3D point clouds. However, the optical sensor can define any other type of optical sensor and can output visual or optical data in any other format.

The motion sensor can include a passive infrared sensor (or “PIR” sensor) that defines a field of view that overlaps the field of view of the optical sensor and that passively outputs a signal representing motion within (or near) the field of view of the optical sensor. Furthermore, the sensor block can transition from an inactive state to an active state responsive to an output from the motion sensor indicating motion in the field of view of the motion sensor; the sensor block can then trigger the optical sensor to record an image (e.g., a 2D color image), which may capture a source of the motion detected by the motion sensor.

In one example, the motion sensor is coupled to a wake interrupt pin on the processor. However, the motion sensor can define any other type of motion sensor and can be coupled to the processor in any other way.

In one variation, the sensor block also includes: a distance sensor (e.g., a 1D infrared depth sensor); an ambient light sensor; a temperature sensor; an air quality or air pollution sensor; and/or a humidity sensor. However, the sensor block can include any other ambient sensor. In the active state, the sensor block can sample and record data from these sensors and can selectively transmit these data—paired with insights extracted from images recorded by the sensor block—to a local gateway. The sensor block can also include a solar cell or other energy harvester configured to recharge the battery.

The processor can locally execute Blocks of the method S100, as described above and below, to selectively wake responsive to an output of the motion sensor, to trigger the optical sensor to record an image, to write various insights extracted from the image, and to then queue the wireless communication module to broadcast these insights to a nearby gateway for distribution to the remote computer system when these insights exhibit certain target conditions or represent certain changes.

The optical sensor, motion sensor, battery, processor, and wireless communication module, etc. can be arranged within a single housing configured to install on a flat surface—such as by adhering or mechanically fastening to a wall or ceiling—with the field of view of the optical sensor facing outwardly from the flat surface and intersecting an area of interest within the facility. Furthermore, the housing can include a universal serial bus (or “USB”) port configured to receive an external memory drive for network settings updates, decryption of images, and/or data transfers.

However, this “standalone,” “mobile” sensor block can define any other form and can mount to a surface in any other way.

### 3.1 Wired Power and Communications

In one variation, the sensor block additionally or alternatively includes a receptacle or plug configured to connect to an external power supply within the facility—such as a power-over-Ethernet cable—and sources power for the camera, processor, etc. from this external power supply. In this variation, the sensor block can additionally or alternatively transmit data—extracted from images recorded by the sensor block—to the computer system via this wired connection (i.e., rather than wirelessly transmitting these data to a local gateway) according to a predefined data packet threshold/filter.

### 3.2 Optical Sensor: Image Capture

Once a sensor block is installed and activated (e.g., connected to network settings of the facility) within a space, the sensor block can intermittently trigger the optical sensor to capture a discrete encrypted image or sequence of discrete encrypted images. For example, the sensor block can capture a sequence of 20 images at a frame rate of 2 Hz (i.e., over 10 seconds) or 0.2 Hz (e.g., over 100 seconds) in response to detection of motion within the field of view of the optical sensor (e.g., via a motion sensor arranged in the sensor block).

Additionally or alternatively, the sensor block can capture the sequence of images at the previously mentioned frame rates in response to passage of ten minutes since a last sequence of images was captured by the sensor block. Furthermore, the sensor block can capture a sequence of images in response to a maximum time of two minutes passing between capture of consecutive sequences of images.

However, the sensor block can capture images at any other frame rate, responsive to any other event, and with any other minimum or maximum times between consecutive sequences of images.

### 3.3 Rolling Data Buffer+Write-Only Memory

In one variation, each sensor block can be configured to contain a rolling buffer to store data (e.g., images, frames) for a particular period of time (e.g., one minute, five minutes) in local memory of the sensor block. Additionally or alternatively, the rolling buffer can store optical data in local memory of the sensor block until the images stored reaches an image storage threshold (e.g., 100 images). Furthermore, the rolling buffer can discard images in response to the particular period of time expiring or in response to reaching the image storage threshold. Thus, the rolling buffer limits access to data stored in local memory of each sensor block deployed in the facility to the particular period of time or a window of time to reach the image storage threshold.

Furthermore, the local memory of each sensor block can be configured to be write-only memory such that the local memory cannot be read by the processor of the sensor block writing to the local memory. However, an external memory drive can read the local memory of the sensor block to download and/or transfer data via the secure digital key stored in memory of the external memory drive. Thus, data stored on the sensor block can only be accessed by the external memory drive with a secure digital key that match the unique identifier (e.g., a UUID, MAC address, IP address, or other wireless address, etc.) pertaining to the sensor block.

Therefore, the sensor block can include a rolling buffer and write-only memory and can interface with an external memory drive to control access to raw or photographic data captured by the sensor block, enforce privacy of humans depicted in images captured by the sensor block, and enable further security protocols for the network infrastructure in the facility.

### 4. Local Gateway

The method S100 can also include a local gateway: configured to receive data transmitted from sensor blocks nearby via a wireless or wired communication protocol or via a local ad hoc wireless network; and to pass these non-optical data to the computer system, such as over a computer network or long-range wireless communication protocol. For example, the gateway can be installed near and connected to a wall power outlet and can pass data received from a nearby sensor block to the computer system in (near) real-time. Furthermore, multiple gateways can be installed throughout the facility and can interface with sets of sensor blocks installed nearby to collect data from these sets of sensor blocks and to return these data to the computer system.

In one variation, a sensor block transmits a sequence of (raw or compressed) images—recorded by the optical sensor during a scan cycle executed by the sensor block while in an active state—to a nearby gateway. The gateway can extract insights from this sequence of images and return these insights to the computer system (e.g., scans the raw or compressed sequence of images).

### 5. Sensor Block Output

Generally, each sensor block can generate non-optical data and optical data, annotate these data, and transmit these data to the computer system, local gateway, and/or the external memory drive. More specifically, for a setup sampling period (e.g., once per ten-minute interval when the sensor block is activated), each sensor block can receive a cluster of digital keys via the external memory drive, establish a connection with the network settings of the facility, and capture an encrypted image. Furthermore, each sensor block can annotate the encrypted image with a timestamp and an unique identifier (e.g., a UUID, MAC address, IP address, or other wireless address, etc.) pertaining to each sensor block and transmit this annotated image to the computer system, such as via the external memory drive and/or via a wired or wireless connection (e.g., via the local gateway).

In one variation, the sensor block can capture, encrypt, and store a sequence of images during a first time period. Later, during a second time period, the sensor block can: download a cluster of digital keys via the external memory drive; decrypt the sequence of images based on the cluster of digital keys received from the external memory drive; and offload the sequence of images to the external memory drive and/or transmit the sequence of images to the computer system (e.g., via the gateway) for further manipulation and insight extraction by the computer system; and then disable wired or wireless image offloading once the external memory drive is removed from the sensor block.

### 5.1 Primary Sensor Block+Output

In one variation, the method S100 can also include a primary sensor block configured to broadcast network settings and updates to all other sensor blocks (e.g., worker sensor blocks) throughout the facility. Furthermore, the primary sensor block can be installed nearby a user's (e.g., administrator or manager of the facility) agile work environment, thereby enabling quick access for the user to connect the external memory drive to the primary sensor block.

For example, the primary sensor block can be installed above the agile work environment of a user (e.g., an administrator or manager affiliated with the facility), and the user may insert the external memory drive into the USB port of the primary sensor block. The primary sensor block can receive a secure digital key via the external memory drive and then broadcast—via a secure local ad hoc wireless network—this initial secure digital key to each other sensor block in the facility to establish a wireless network connection between each sensor block and the wireless network setting of the facility.

### 6. Computer System

The computer system—such as a computing device or a remote server—can receive annotated images and non-optical data from one or more gateways installed in the facility (or directly from sensor blocks) and can compile these images and data into a list of locally-activated sensor blocks in the facility over a period of time (e.g., one minute, ten minutes, one hour). More specifically, the computer system can compile the images annotated with timestamps and unique identifiers (e.g., a UUID, MAC address, IP address, or other wireless address, etc.) pertaining to each sensor block into a composite image and/or a map of the workspace.

Furthermore, the computer system can access an activation status list of sensor blocks connected to the wireless network within the workspace (e.g., an activation database of sensor blocks) and match the locally-activated list of unique identifiers with the activation status list of sensor blocks to generate a corresponding block number for each sensor block in the facility. The computer system can also execute actions (e.g., generate notifications) in response to detecting inaccuracies between the locally-activated list of unique identifiers and the activation database of sensor blocks; highlight a region of the map corresponding to a sensor block that did not activate; selectively trigger a prompt for a user to investigate certain sensor blocks that did not activate during a setup period (e.g., sensor block in a dead zone, network connectivity error); serve the highlighted map and the prompt to the user; and/or update or revert a wireless network setting of each sensor block according to a scheduled time (e.g., 9 AM, 11 PM), as described below.

Thus, the computer system can verify activation of all sensor blocks in the facility by comparing the list of locally-activated list of unique identifiers with the activation database of sensor blocks, generate notifications of inaccuracies to the user, and present prompts for the user to investigate a certain sensor block, thereby enabling the user to achieve accurate and reliable sensor block activation throughout the facility.

### 7. External Memory Drive

Generally, the method S100 can include an external memory drive (e.g., universal serial bus flash drive) configured to unlock, activate, and access stored data of each sensor block in a facility. Furthermore, the external memory drive can decrypt images captured at sensor blocks with a pre-installed a secure digital key (or “credentials”). More specifically, the external memory drive can be configured to activate sensor blocks by establishing network connectivity between sensor blocks and the network settings of the facility—such as a WI-FI network, cloud enabled networking, a local ad hoc wireless network—and further transfer data to electronic (e.g., computer monitor, computer system) or cellular devices (e.g., cell phone, tablet, laptop).

In one variation, the external memory drive can be manually installed and connected to each sensor block deployed within the facility, such as by an installer during initial sensor block installation or by an administrator over time. For example, the external memory drive can unlock each sensor block with the pre-installed cluster of digital keys that correspond to a unique identifier (e.g., a UUID, MAC address, IP address, or other wireless address, etc.) pertaining to each sensor block. Once each sensor block is manually unlocked and activated, the external memory drive can transfer network settings to the sensor block to establish network connectivity between the sensor block and the network settings of the facility.

Alternatively, the external memory drive can be configured to receive and store a a secure digital key from a local registered device (e.g., administrator's laptop, local gateway, remote server, computer system) within the facility. The method and techniques of the previous example can be implemented to establish network connectivity to activate each sensor block in the facility via manual installation of the external memory drive.

In another variation, the external memory drive can be connected to a single sensor block and can receive data from this sensor block to pass optical and/or non-optical data from the sensor block to the computer system, such as over a computer network or long-range wireless communication protocol, or to transfer these optical and/or non-optical data via a USB port of an electronic device (e.g., computer monitor, computer system) for review by a user (e.g., administrator, manager, or installer of the facility). For example, the external memory drive can be configured to connect to a single sensor block within the facility and can decrypt data (e.g., images, frames)—stored in local memory (e.g., rolling buffer, write-only memory) of the sensor block—based on a a secure digital key to store in memory. Then, these optical and non-optical data can be transferred to the computer system, local gateway, or a cellular device via manual installation of the external memory drive, by the user, into a USB port.

In yet another variation, the external memory drive can be installed and connected to the primary sensor block within the facility and can unlock and interface with all sensor blocks deployed throughout the facility to establish network connectivity and/or update network settings, as described below.

Therefore, the external memory drive is a higher fidelity network hardware interface that can prevent unauthorized access, modification, deletion, and/or theft of data stored in each sensor block.

### 7.1 Handshake Protocol

Furthermore, the external memory drive can be configured to initiate a handshake protocol—via a key infrastructure (e.g., a secure digital key)—with each sensor block to establish a secure connection prior to updating network settings, decrypting data, and/or transferring data from the sensor block to the external memory drive.

In one variation, the external memory drive can transmit and receive data stored in local memory of each sensor block via a wireless short-range communications protocol to a cellular device (e.g., cell phone, tablet, laptop). More specifically, the wireless short-range communications protocol can be combined with two-factor authentication technology to verify that the cellular device is registered and has established a secure connection. After receiving confirmation of the registered cellular device and completing the handshake protocol, the external memory drive can decrypt the sensor block data and transfer these data from the sensor block to the cellular device.

For example, the sensor block can: capture a first image at an optical sensor arranged in the sensor block; annotate the first image with a first timestamp and a first unique identifier assigned to the sensor block; and upload the first image to the external memory drive. The computer system can then initiate a wireless communications protocol (e.g., wireless short-range communications protocol) with a computing device (e.g., cell phone). In response to receiving verification of the computing device (e.g., cell phone) connected to the wireless network within the workspace, the external memory drive can download the first image to the computer system. The computer system can then: decrypt the first image from the sensor block based on a first digital key; and offload the first image from the sensor block to the computing device (e.g., cell phone) for review by the user.

Thus, the computer system and external memory drive can cooperate to execute a wireless short-range communications protocol and two-factor authentication technology to provide an additional security measure for data within the workspace and to ensure confidentiality of these communicated data.

### 8. Setup Period: USB Stick+Single Sensor Block

In one implementation, the sensor block can be configured to connect and receive the external memory drive during a setup period for activation. During the setup period, the sensor block can execute a handshake protocol with the external memory drive to establish a network connection with the facility to achieve activation status.

In one variation, a user (e.g., administrator, manager affiliated with the facility) can download a secure digital key (e.g., network credentials, passwords) from a registered and secured device within the facility to the external memory drive. Then, an installer can manually insert the external memory drive into the USB port of a sensor block. The sensor block can execute a handshake protocol with the external memory drive and establish a network connection (e.g., Wi-Fi connection) with the facility based on the secure digital key. Once the sensor block is connected to the network setting of the workspace, the sensor block can capture an image annotated with a timestamp and a unique identifier and transfer this image to the external memory drive to populate a list of locally-activated sensor blocks in the facility.

For example, once the sensor block is connected to the wireless network within the workspace and, in response to detecting a second insertion of the external memory drive, the sensor block can: initiate the wireless communication protocol (e.g., handshake protocol) with the external memory drive; receive a second digital key from the external memory drive; access a first sequence of images captured by an optical sensor arranged in the first sensor block; decrypt the first sequence of images based on the first digital key; and upload the first sequence of images to the external memory drive. Then, the external memory drive can download the list of unique identifiers and the first sequence of images to the computing device (e.g., computer system) for verification of activation of the first sensor block, as further described below.

Therefore, the installer may implement and repeat this method for each other sensor block in the facility to activate all sensor blocks and establish network connectivity with the facility. Each other sensor block can also implement Blocks of the method S100 to capture, annotate, and transfer an image and/or a sequence of images to the computer system and/or local gateway to complete the list of locally-activated sensor blocks in the facility.

### 9. Post Setup Period: Computer System Activation Check

Furthermore, after the installer has activated each sensor block in the facility, the computer system can access the populated list of locally-activated sensor blocks stored in memory of the external memory drive to execute a sensor block activation check.

In one implementation, the computer system can: access an activation status list of sensor blocks connected to the wireless network within the workspace; characterize a difference between the list of unique identifiers and the activation status list of sensor blocks; and generate a notification to investigate the difference between the list of unique identifiers and the activation status list of sensor blocks connected to the network within the workspace.

In one variation, the user may insert the external memory drive into a USB port of the computer system, and the computer system can access the populated list of unique identifiers stored in memory of the external memory drive. The computer system can then pair (e.g., match, correlate) each unique identifier in the list with a corresponding sensor block-to-gateway connection recorded at the computer system during the setup period, according to an activation database of sensor blocks. In response to all unique identifiers pairing with a corresponding sensor block-to-gateway connection and matching the activation database of sensor blocks, the computer system can generate a notification to alert the user that all sensor blocks were activated in the facility during the setup period.

For example, the user may insert the external memory drive into a USB port of a computing device, and the computing device can access the activation database of sensor blocks. The computing device can then: scan the activation database for a unique identifier assigned to a particular sensor block; and, in response to the activation database of sensor blocks containing the first unique identifier assigned to the particular sensor block, annotate the unique identifier with an activation status of activated within the list of unique identifiers.

Additionally or alternatively, in response to the list of locally-activated sensor blocks not corresponding to (e.g., matching with) the activation database of sensor blocks, the computer system can generate a notification alerting the user that an error occurred during the setup period and present a list—via a user portal—of particular sensor blocks (e.g., sensor block 34, sensor block 25) that are offline and did not activate as planned during the setup period.

Therefore, the computer system can verify that each sensor block is activated during the setup period by comparing the list of unique identifiers from the external memory drive to the activation database of sensor blocks and generate notifications to alert the user if any activation inaccuracies occurred during the setup period.

### 10. Network Connectivity Reset Period

Generally, in response to a change and/or update to the network settings of the facility, the computer system can generate a notification alerting the user (e.g., administrator or manager affiliated with the facility) to download the new network settings (e.g., a secure digital key, a Wi-Fi password, or network credentials) to the external memory drive and to insert the external memory drive into each sensor block deployed in the workspace to update the network settings.

In one variation, responsive to a change in the network settings of the facility, the computer system can generate a notification alerting the user that all sensor blocks are offline. Furthermore, the computer system can prompt the user to download the new network settings to the external memory drive and to insert the external memory drive manually and individually into each sensor block in the facility. The user may manually insert the external memory drive into the USB port of each sensor block until all sensor blocks have received the updated network settings. Additionally or alternatively, the computer system can update the network settings at each sensor block at a scheduled time to reconnect all the sensor blocks in the facility.

In another variation, the computer system can generate a notification alerting the user that all sensor blocks are offline. Additionally, the computer system can prompt the user to download the new network settings to the external memory drive and to manually insert the external memory drive into the USB port of the primary sensor block. The primary sensor block can simultaneously broadcast the new network settings to each sensor block in the facility via the local ad hoc wireless network to achieve updated network settings at all sensor blocks.

### 10.1 Network Settings Update+Manual External Memory Drive Insertion

In one variation, the network settings or credentials of the facility are changed or updated, and the computer system can alert the user (e.g., administrator or manager of the facility) that all sensor blocks are offline, and the network settings must revert to the original network settings.

For example, after the setup period, the network settings of the facility may be updated according to a previously defined schedule to maintain a secure wireless network. Accordingly, the computer system can identify all sensor blocks as offline (e.g., not connected to the network) and generate a notification alerting the user that all sensor blocks are offline and to revert all sensor blocks to the original network settings. Then, the computer system can simultaneously update each sensor block—via the local ad hoc wireless network—to the updated network settings at a scheduled time (e.g., 11 PM, 6 AM) to reconnect all the sensor blocks in the facility.

Additionally or alternatively, the computer system can generate a notification for the user to manually update each sensor block via the external memory drive to change all sensor blocks to the updated network settings. In particular, the computer system can identify all sensor blocks as offline (e.g., not connected to the network) and generate a notification alerting the user to download the updated network settings to the external memory drive. Then, the user may manually insert the external memory drive into the USB port of each sensor block to change each sensor block to the updated network settings such that all sensor blocks are activated and online.

For example, the computer system can detect a sensor block disconnected from the first wireless network setting of the workspace and, in response to detecting the sensor block disconnected from the first wireless network setting of the workspace: flag the unique identifier of the sensor block within the unique identifier list; extract a first location of the sensor block from the activation status list of the population of sensor blocks deployed in the workspace; and generate a notification for the user to insert the external memory drive into the sensor block. Then, in response to receiving confirmation of activation of the first sensor block from the user, the computer system can update the activation status list of the population of sensor blocks to represent the sensor block as activated.

The computer system can similarly repeat methods and techniques described above for each other sensor block identified as offline to achieve activation of all sensor blocks deployed in the workspace with the updated network settings.

### 10.2 Network Settings Update+Primary Sensor Block

In one variation shown in FIG. 2B, following the setup period, the external memory drive can be inserted into the USB port of the primary sensor block and the primary sensor block can broadcast a network settings update to all sensor blocks in the facility. Furthermore, in response to a change in the network settings of the facility, the computer system can generate a notification for the user to manually update a primary sensor block via the external memory drive and the primary sensor block can broadcast the updated network settings to all sensor blocks in the facility via the mesh network.

More specifically, the primary sensor block can be installed above the desk of the user (e.g., administrator of the facility), which allows the user to quickly insert the external memory drive into the primary sensor block in the event of a change to the network settings. Furthermore, in response to a network settings change (e.g., new Wi-Fi password, new network credentials) within the facility, the computer system can: generate a notification that alerts the user that all sensor blocks are offline (e.g., not connected to the network); and prompt the user to manually insert the external memory drive with the updated network settings (e.g., a secure digital key) into the USB port of the primary sensor block. More specifically, the user may download the updated network settings from a registered, secure device (e.g., administrator's laptop, local gateway) within the facility to the external memory drive and then the user may manually insert the external memory drive into the USB port of the primary sensor block. The primary sensor block can implement methods and techniques described above to execute the handshake protocol with the external memory drive and receive the updated a secure digital key. The primary sensor block can also broadcast the updated network settings to all other sensor blocks in the facility according to the updated cluster of digital keys—via the secure local ad hoc wireless network—to activate all other sensor blocks within the facility.

For example, the computer system can detect a second wireless network setting associated with the workspace and, in response to detecting a difference between the first wireless network setting and the second wireless network setting: upload the second wireless network setting to the external memory drive; and generate a notification for the user to insert the external memory drive into a primary sensor block in the population of sensor blocks. Then, in response to detecting an insertion of the external memory drive, the primary sensor block can: initiate the wireless communication protocol (e.g., handshake protocol) with the external memory drive; receive a digital key and/or a secure digital key from the external memory drive; and access the second wireless network setting associated with the workspace from the external memory drive based on the digital key and/or the a secure digital key. The primary sensor block can then: connect to the wireless network within the workspace via the second wireless network setting; and broadcast the second wireless network setting to each sensor block in the population of sensor blocks deployed in the workspace.

Therefore, the primary sensor block can broadcast the updated network settings to all sensor blocks in the mesh network and thus reduce the time for the user to insert the external memory drive manually and individually into each sensor block in the facility to update the network settings.

### 11. Data Transfer: Decryption+Image Offload

Generally, the sensor block can be configured to connect to the external memory drive and can decrypt data (e.g., images, frames)—stored in local memory (e.g., rolling buffer, write-only memory)—based on the secure digital key from the external memory drive. Then a user may transfer these data to the computer system and/or local gateway via manual installation of the external memory drive into a USB port.

More specifically, each sensor block in the population of sensor blocks can capture an image and/or a sequence of images during an image capture cycle and store these images in a rolling buffer. Each sensor block can then decrypt the image and/or the sequence of images based on the secure digital key from the external memory drive and upload the image and/or the sequence of images to the external memory drive.

In one implementation, the sensor block can: include write-only memory; and store data (i.e., images) on a rolling buffer (e.g., ten recent images recorded over a preceding 90-minute interval). The user may then insert the external memory drive into the sensor block, thereby triggering the sensor block to decrypt data stored in the rolling buffer and to prepare these data for transfer to the computer system, to the local gateway, or to the external memory drive. For example, the user may then insert the external memory drive into the sensor block following a theft or emergency event near the sensor block. Upon detecting insertion of the external memory drive into the sensor block, the sensor block can: download a decryption key from the external memory drive; decrypt images stored in the rolling buffer according to this decryption key; write these images onto the external memory drive; and/or wirelessly transmit these images to the gateway.

In another implementation, the user may disconnect the local gateway from the network (e.g., a local area network, a wide area network, ethernet, internet) and allow the mesh network of sensor blocks to securely communicate and transfer data with the primary sensor block. The data stored in each sensor block can only be transferred from the primary sensor block via the external memory drive, which prevents a security breach of the data stored in each sensor block.

### 11.1 Decryption+Image Offload

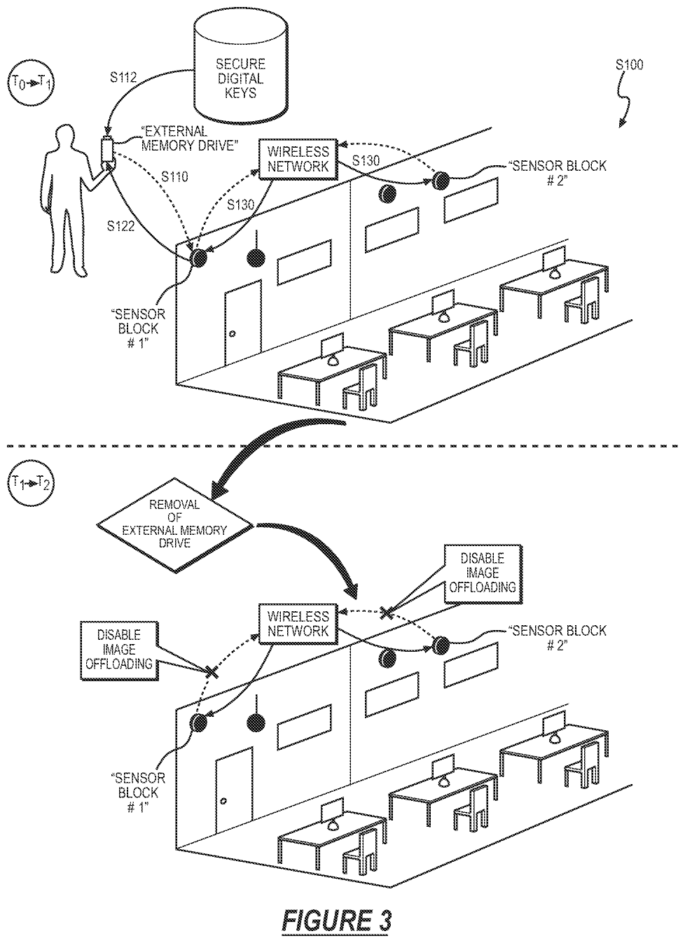

In one variation shown in FIG. 3, the computer system can transmit the image and/or the sequence of images via the wireless network within the workspace to a computing device (e.g., a computer system, a remote server, a cellular device, a laptop, a tablet). The computing device can then aggregate the images into a composite image or a map of the workspace, as further described below. Each sensor block can then disable wireless and/or wired image offloading to a computing device upon removal of the external memory drive from the sensor block.

For example, a first sensor block can: capture a first image at an optical sensor arranged in the first sensor block; annotate the first image with a first timestamp and a first unique identifier assigned to the first sensor block; decrypt the first image based on the first digital key from the external memory drive; and transmit the first image via the wireless network to the computing device. Then, a second sensor block can: capture a second image at an optical sensor arranged in the second sensor block; annotate the second image with a second timestamp and a second unique identifier assigned to the second sensor block; decrypt the second image based on the second digital key from the external memory drive; and transmit the second image via the wireless network to the computing device. Then, in response to detecting a first removal of the external memory drive, the first sensor block can disable wireless image offloading to the computing device via the wireless network within the workspace. Similarly, in response to detecting a second removal of the external memory drive, the second sensor block can disable wireless image offloading to the computing device via the wireless network within the workspace.

Additionally or alternatively, the first sensor block can transmit the first image via the local gateway within the workspace to a computer system. Then, in response to detecting a first removal of the external memory drive, the first sensor block can disable wired image offloading to the computer system via the local gateway within the workspace. Similarly, the second sensor block can transmit the second image via the local gateway to the computer system and, in response to detecting a second removal of the external memory drive, disable wired image offloading to the computer system via the local gateway within the workspace.

Thus, the sensor block can decrypt an image and/or a sequence of images with the secure digital key from the external memory drive and selectively disable wireless and wired image offloading to a computing device upon detection of removal of the external memory drive from the sensor block.

### 11.2 Sensor Block: Rolling Buffer+Image Quantity Threshold

In one implementation, each sensor block can be configured to contain a rolling buffer to store data (e.g., images, frames) for a particular period of time (e.g., one minute, five minutes, 20 minutes) in local memory of the sensor block or until the local memory reaches an image storage threshold (or “image quantity threshold”). The memory of the sensor block can also be configured to be a write-only memory such that the processor of the sensor block cannot read the local memory. However, the external memory drive can read the memory, download a decryption key to the sensor block to decrypt the raw images stored on the sensor block, and transfer these images to the computer system and/or local gateway, as described above.

In one variation, the user (e.g., administrator or manager affiliated with the facility) can configure the rolling buffer of each sensor block to store raw compressed images for ten minutes. The user may also define an image storage threshold of 100 images for each sensor block. During the rolling buffer time period and before the local memory reaches the image storage threshold, the user may manually insert the external memory drive with the pre-installed digital key into a sensor block. The sensor block can implement the methods and techniques described above to execute the handshake protocol with the external memory drive, decrypt the raw compressed images based on the secure digital key, and transfer these raw compressed images to memory of the external memory drive. Once the raw compressed images are transferred to the external memory drive, the user may remove the external memory drive and connect the external memory drive to the computer system and/or local gateway to extract insights of the facility from these images.

Later, in response to expiration of the ten-minute period, the sensor block can discard the raw compressed images collected during this period of time and begin a new cycle for data storage. Alternatively, in response to the storage reaching 100 images, the sensor block can discard the 100 raw compressed images and begin a new cycle for data storage.

For example, the sensor block can: execute a first image capture cycle assigned to a first time interval associated with a rolling buffer of the sensor block; and access a first sequence of images captured by an optical sensor arranged in the sensor block during the first time interval. Then, in response to detecting a second insertion of the external memory drive, the sensor block can: download a decryption key from the external memory drive; decrypt the first sequence of images stored in the rolling buffer according to the decryption key; and upload the first sequence of images to the external memory drive. The external memory drive can then upload the first sequence of images to a computing device (e.g., a computer system). Accordingly, in response to detecting expiration of the first time interval, the sensor block can: terminate the first image capture cycle; discard the first sequence of images from the rolling buffer of the first sensor block; and initiate a second image capture cycle assigned to the first time interval.

Additionally, the sensor block can execute the first image capture cycle assigned to an image quantity threshold associated with the rolling buffer. During the first time interval, the sensor block can: access a first sequence of images captured by an optical sensor arranged in the sensor block; and detect a quantity of the first sequence of images. Then, in response to the quantity of the first sequence of images falling below the image quantity threshold associated with the rolling buffer of the sensor block, the sensor block can upload the first sequence of images to the external memory drive.

Accordingly, the sensor block can execute the first image capture cycle assigned to the first time interval associated with the rolling buffer and assigned to an image quantity threshold associated with the rolling buffer. The sensor block can then detect a quantity of the first sequence of images and, in response to the quantity of the first sequence of images falling below the image quantity threshold and in response to detecting a second insertion of the external memory drive: download a decryption key from the external memory drive; decrypt the first sequence of images stored in the rolling buffer according to the decryption key; and upload the first sequence of images to the external memory drive.

Alternatively, the sensor block can detect a quantity of the first sequence of images. In response to the first sequence of images corresponding to (e.g., matching, analogous to) the image quantity threshold, the sensor block can: discard the first sequence of images from the rolling buffer of the sensor block; and initiate a second image capture cycle assigned to the first time interval.

Therefore, the sensor block, the external memory drive, and/or the computer system can leverage the time interval and/or the image quantity threshold associated with the rolling buffer of the sensor block to upload images and/or to discard images and initiate a next image capture cycle for the sensor block.

### 11.2 Local Gateway Offline+Sensor Block Communication

In one variation, the user may disconnect the local gateway from the network (e.g., a local area network, a wide area network, ethernet, internet) and allow the mesh network of sensor blocks to securely communicate and transfer data (e.g., images, frames, insights) with the primary sensor block.

For example, the user may remove the PoE cord from the local gateway and insert the external memory drive into the USB port of the primary sensor block. Then, the primary sensor block can implement the methods and techniques described above to execute the handshake protocol with the external memory drive and communicate with all other sensor blocks in the facility to receive data (e.g., images, frames, insights) from each individual sensor block according to the secure digital key on the external memory drive. The primary sensor block can transfer these collected data from each sensor block to the external memory drive memory. After the data is transferred to the external memory drive, the user may remove the external memory drive from the primary sensor block and reconnect the PoE cord to the local gateway.

Therefore, the data stored on the sensor blocks can only be accessed if the external memory drive is connected to the sensor block. Additionally, the user prevents unauthorized access to cloud network settings and to the data stored on the sensor blocks by disconnecting the local gateway from the network (e.g., a local area network, a wide area network, ethernet, internet).

### 12. Image Offload: Composite Image+Map of Workspace

Furthermore, after the computer system receives these decrypted data during the rolling buffer time period, the computer system can aggregate optical data (e.g., images) captured by the population of sensor blocks into a composite image and/or a map of the workspace representing locations of sensor blocks deployed in the workspace.

In one implementation, the computer system can aggregate a first image from a first sensor block and a second image from a second sensor block into a map of the workspace representing locations of sensor blocks deployed in the workspace. The computer system can then: project the activation status list of sensor blocks onto the map of the workspace; detect a deviation between the first unique identifier assigned to the first sensor block and the activation status list of sensor blocks within the map of the workspace; highlight a region of the map of the workspace exhibiting the deviation; generate a notification for the user to investigate the deviation; and serve the notification and the highlighted region of the map of the workspace to the user to investigate the deviation.

In another implementation, the computer system can: receive a first sequence of images from the first sensor block; aggregate the first sequence of images into a composite image of the workspace representing locations of sensor blocks deployed in the workspace; project the activation status list of sensor blocks onto the composite image of the workspace; and, in response to detecting the activation status list corresponding to a unique identifier assigned to the first sensor block, annotate the first sensor block as activated within the composite image of the workspace. The computer system can then generate a notification indicating the first sensor block status as activated.

Therefore, the computer system can leverage the activation status list and the unique identifier of each sensor block in the population of sensor blocks to identify each sensor block as activated and/or as offline based on a deviation between the activation status list and the unique identifier list.

### 12. Composite Image: Single Sensor Block Offline+Primary Sensor Block

In one variation, the computer system can detect a sensor block in the population of sensor blocks as offline and generate a prompt for the user to insert the external memory drive into the USB port of the primary sensor block to broadcast a network setting update to the offline sensor block via the mesh network. Furthermore, the computer system can highlight the region of the composite image and/or map corresponding to the offline sensor block and serve the prompt and the highlighted region to the user.

For example, the computer system can: detect a sensor block in the population of sensor blocks disconnected from the wireless network within the workspace; highlight the region of the composite image corresponding to this sensor block; generate a prompt for the user to insert the external memory drive into a primary sensor block in the population of sensor blocks; and serve the prompt and the region of the composite image to the user to connect the sensor block, in the population of sensor blocks, to the wireless network within the workspace. Then, in response to detecting an insertion of the external memory drive, the primary sensor block can: initiate the wireless communication protocol (e.g., handshake protocol) with the external memory drive; receive the first digital key from the external memory drive; access the first wireless network setting associated with the workspace from the external memory drive based on the first digital key; connect to the wireless network within the workspace via the first wireless network setting; and broadcast the first wireless network setting to the sensor block in the population of sensor blocks deployed in the workspace via the mesh network.

Therefore, the computer system can cooperate with the primary sensor block to enable the user to quickly establish a wireless network connection between an offline sensor block and the wireless network setting of the workspace by reviewing the highlighted region of the composite image and/or map of the workspace.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for network provisioning within a workspace comprising:
at a first sensor block deployed in the workspace:
in response to detecting a first insertion of an external memory drive:
initiating a wireless communication protocol with the external memory drive;
receiving a first digital key from the external memory drive;
accessing a first wireless network setting associated with the workspace from the external memory drive based on the first digital key; and
uploading a first unique identifier assigned to the first sensor block to the external memory drive; and
connecting to a wireless network within the workspace according to the first wireless network setting;
at the external memory drive:
writing the first unique identifier to a list of unique identifiers corresponding to a population of sensor blocks comprising the first sensor block and deployed throughout the workspace; and
downloading the list of unique identifiers to a computing device; and
at the computing device:
accessing an activation status list of sensor blocks connected to the wireless network within the workspace;
characterizing a difference between the list of unique identifiers and the activation status list of sensor blocks; and
generating a notification for a user to investigate the difference between the list of unique identifiers and the activation status list of sensor blocks connected to the wireless network within the workspace.

2. The method of claim 1, further comprising, at the computing device:
detecting the first sensor block disconnected from the first wireless network setting of the workspace;
in response to detecting the first sensor block disconnected from the first wireless network setting of the workspace:
flagging the unique identifier of the first sensor block within the unique identifier list;
extracting a first location of the first sensor block from the activation status list of the population of sensor blocks deployed in the workspace; and
generating a second notification for the user to insert the external memory drive into the first sensor block; and
in response to receiving confirmation of activation of the first sensor block from the user, updating the activation status list of the population of sensor blocks to represent the first sensor block as activated.

3. The method of claim 1, further comprising:
at the computing device:
detecting a second wireless network setting associated with the workspace; and
in response to detecting a difference between the first wireless network setting and the second wireless network setting:
uploading the second wireless network setting to the external memory drive; and
generating a second notification for the user to insert the external memory drive into a primary sensor block in the population of sensor blocks; and
at the primary sensor block:
in response to detecting a second insertion of the external memory drive:
initiating the wireless communication protocol with the external memory drive;
receiving a second digital key from the external memory drive; and
accessing the second wireless network setting associated with the workspace from the external memory drive based on the second digital key;
connecting to the wireless network within the workspace via the second wireless network setting; and
broadcasting the second wireless network setting to each sensor block in the population of sensor blocks deployed in the workspace.

4. The method of claim 1:
further comprising, at the first sensor block:
capturing a first image at an optical sensor arranged in the first sensor block;
annotating the first image with a first timestamp and the first unique identifier assigned to the first sensor block; and
uploading the first image to the external memory drive; and
further comprising, at the external memory drive:
initiating a wireless communications protocol with the computing device; and
in response to receiving verification of the computing device connected to the wireless network within the workspace:
decrypting the first image from the first sensor block based on the first digital key; and
offloading the first image from the first sensor block to the computing device for review by the user.

5. The method of claim 1, further comprising:
at the first sensor block:
capturing a first image at an optical sensor arranged in the first sensor block;
annotating the first image with a first timestamp and the first unique identifier assigned to the first sensor block;
decrypting the first image based on the first digital key from the external memory drive; and
transmitting the first image via the wireless network to the computing device;
at a second sensor block, in the population of sensor blocks, connected to the wireless network within the workspace:
capturing a second image at a second optical sensor arranged in the second sensor block;
annotating the second image with a second timestamp and a second unique identifier assigned to the second sensor block;
decrypting the second image based on the first digital key from the external memory drive; and
transmitting the second image via the wireless network to the computing device; and
at the computing device:
receiving the first image from the first sensor block and the second image from the second sensor block; and
aggregating the first image and the second image into a composite image of the workspace representing locations of sensor blocks deployed in the workspace.

6. The method of claim 5, further comprising:
at the first sensor block:
in response to detecting a first removal of the external memory drive, disabling wireless image offloading to the computing device via the wireless network within the workspace; and
at the second sensor block:
in response to detecting a second removal of the external memory drive, disabling wireless image offloading to the computing device via the wireless network within the workspace.

7. The method of claim 5:
wherein aggregating the first image and the second image into the composite image of the workspace comprises aggregating the first image and the second image into a map of the workspace representing locations of sensor blocks deployed in the workspace;
further comprising, at the computing device, projecting the activation status list of sensor blocks onto the map of the workspace;
wherein characterizing the difference between the list of unique identifiers and the activation status list of sensor blocks comprises detecting a deviation between the first unique identifier assigned to the first sensor block and the activation status list of sensor blocks within the map of the workspace; and
wherein generating the notification for the user to investigate the difference between the list of unique identifiers and the activation status list of sensor blocks comprises:
highlighting a region of the map of the workspace exhibiting the deviation; and
generating the notification for the user to investigate the deviation.

8. The method of claim 5:
wherein transmitting the first image to the computing device comprises transmitting the first image via a local gateway within the workspace to the computing device comprising a computer system;
further comprising, at the first sensor block:
in response to detecting a first removal of the external memory drive, disabling wired image offloading to the computer system via the local gateway within the workspace;
wherein transmitting the second image to the computing device comprises transmitting the second image via the local gateway to the computer system; and
further comprising, at the second sensor block, in the population of sensor blocks:
in response to detecting a second removal of the external memory drive, disabling wired image offloading to the computer system via the local gateway within the workspace.

9. The method of claim 5:
wherein characterizing the difference between the list of unique identifiers and the activation status list of sensor blocks comprises:
detecting the second sensor block in the population of sensor blocks disconnected from the wireless network within the workspace; and
highlighting the region of the composite image corresponding to the second sensor block;
wherein generating the notification for the user to investigate the difference between the list of unique identifiers and the activation status list of sensor blocks comprises:
generating a prompt for the user to insert the external memory drive into a primary sensor block in the population of sensor blocks; and
serving the prompt and the region of the composite image to the user to connect the second sensor block, in the population of sensor blocks, to the wireless network within the workspace; and
further comprising, at the primary sensor block:
in response to detecting a second insertion of the external memory drive:
initiating the wireless communication protocol with the external memory drive;
receiving the first digital key from the external memory drive; and
accessing the first wireless network setting associated with the workspace from the external memory drive based on the first digital key;
connecting to the wireless network within the workspace via the first wireless network setting; and
broadcasting the first wireless network setting to the second sensor block in the population of sensor blocks deployed in the workspace.

10. The method of claim 1:
further comprising, at the first sensor block deployed in the workspace:
in response to detecting a second insertion of the external memory drive:
initiating the wireless communication protocol with the external memory drive;
receiving a second digital key from the external memory drive;
accessing a first sequence of images captured by an optical sensor arranged in the first sensor block;
decrypting the first sequence of images based on the first digital key; and
uploading the first sequence of images to the external memory drive; and
wherein downloading the list of unique identifiers to the computing device comprises downloading the list of unique identifiers and the first sequence of images to the computing device for verification of activation of the first sensor block.

11. The method of claim 1, further comprising, at the first sensor block:
executing a first image capture cycle assigned to a first time interval associated with a rolling buffer of the first sensor block;
during the first time interval, accessing a first sequence of images captured by an optical sensor arranged in the first sensor block;
in response to detecting a second insertion of the external memory drive:
downloading a decryption key from the external memory drive;
decrypting the first sequence of images stored in the rolling buffer according to the decryption key; and
uploading the first sequence of images to the external memory drive; and
in response to detecting expiration of the first time interval:
terminating the first image capture cycle;
discarding the first sequence of images from the rolling buffer of the first sensor block; and
initiating a second image capture cycle assigned to the first time interval.

12. The method of claim 11:
wherein executing the first image capture cycle assigned to the first time interval associated with the rolling buffer of the first sensor block comprises executing the first image capture cycle:
assigned to the first time interval associated with the rolling buffer; and
assigned to an image quantity threshold associated with the rolling buffer;
further comprising, during the first time interval, detecting a first quantity of the first sequence of images; and
further comprising, in response to the first quantity of the first sequence of images falling below the image quantity threshold and in response to detecting a second insertion of the external memory drive:
downloading a decryption key from the external memory drive;
decrypting the first sequence of images stored in the rolling buffer according to the decryption key; and
uploading the first sequence of images to the external memory drive.

13. The method of claim 11:
executing a first image capture cycle:
assigned to a first time interval associated with a rolling buffer of the first sensor block; and
assigned to an image quantity threshold associated with the rolling buffer;
during the first time interval:
accessing a first sequence of images captured by an optical sensor arranged in the first sensor block; and
detecting a first quantity of the first sequence of images; and
in response to the first quantity of the first sequence of images corresponding to the image quantity threshold:
discarding the first sequence of images from the rolling buffer of the first sensor block; and
initiating a second image capture cycle assigned to the first time interval.

14. The method of claim 1, further comprising:
at the first sensor block:
accessing a first image capture cycle defining an image quantity threshold associated with a rolling buffer of the first sensor block;
accessing a first sequence of images captured by an optical sensor arranged in the first sensor block;
detecting a first quantity of the first sequence of images; and
in response to the first quantity of the first sequence of images falling below an image quantity threshold associated with the rolling buffer of the first sensor block, uploading the first sequence of images to the external memory drive.

15. The method of claim 1:
wherein accessing the activation status list of sensor blocks comprises accessing an activation database of sensor blocks; and
further comprising, at the computing device:
scanning the activation database of sensor blocks for the first unique identifier assigned to the first sensor block; and
in response to detecting the activation database of sensor blocks containing the first unique identifier assigned to the first sensor block, annotating the first unique identifier with a first activation status of activated within the list of unique identifiers.

16. A method for network provisioning within a workspace comprising:
at an external memory drive:
initiating a wireless communication protocol with a first sensor block deployed in the workspace;
downloading a first key to the first sensor block, the first key containing a wireless network setting associated with the workspace;
retrieving a first unique identifier assigned to the first sensor block; and
in response to receiving confirmation of the first sensor block connected to the wireless network setting from a computing device:
writing the first unique identifier to a list of unique identifiers corresponding to a population of sensor blocks comprising the first sensor block and deployed throughout the workspace; and
downloading the list of unique identifiers to a computing device; and
at the computing device:
accessing an activation status list of sensor blocks connected to the wireless network within the workspace;
characterizing a difference between the list of unique identifiers and the activation status list of sensor blocks; and
generating a notification to investigate the difference between the list of unique identifiers and the activation status list of sensor blocks connected to the network within the workspace.

17. The method of claim 16, further comprising:
at the first sensor block deployed in the workspace:
in response to detecting a first insertion of the external memory drive:
receiving the first key from the external memory drive;
accessing the wireless network setting associated with the workspace from the external memory drive based on the first key; and
uploading the first unique identifier assigned to the first sensor block to the external memory drive;
connecting to a wireless network within the workspace via the wireless network setting;
capturing a first sequence of images at an optical sensor arranged in the first sensor block; and
transmitting the first sequence of images to the computing device via the wireless network within the workspace; and
at the computing device:
receiving the first sequence of images from the first sensor block; and
aggregating the first sequence of images into a composite image of the workspace representing locations of sensor blocks deployed in the workspace.

18. A method for network provisioning within the workspace comprising:
at a first sensor block deployed in the workspace:
in response to detecting a first insertion of an external memory drive:
initiating a wireless communication protocol with the external memory drive;
receiving a first digital key from the external memory drive;
accessing a wireless network setting associated with the workspace from the external memory drive based on the first digital key; and
uploading a first unique identifier assigned to the first sensor block to the external memory drive;
connecting to the wireless network within the workspace via the wireless network setting;
capturing a first sequence of images at an optical sensor arranged in the first sensor block;
annotating the first sequence of images with a corresponding timestamp and the first unique identifier assigned to the first sensor block; and
in response to detecting a second insertion of the external memory drive, uploading the first sequence of images to the external memory drive; and
at the external memory drive:
writing the first unique identifier to a list of unique identifiers corresponding to a population of sensor blocks comprising the first sensor block and deployed throughout the workspace; and
downloading the list of unique identifiers and the first sequence of images to a computing device for verification of activation of the first sensor block.

19. The method of claim 18, further comprising, at the computing device:
accessing an activation status list of sensor blocks connected to the wireless network within the workspace;
characterizing a difference between the list of unique identifiers and the activation status list of sensor blocks; and
generating a notification to investigate the difference between the list of unique identifiers and the activation status list of sensor blocks connected to the network within the workspace.

20. The method of claim 18, further comprising, at the computing device:
receiving the first sequence of images from the first sensor block;
aggregating the first sequence of images into a composite image of the workspace representing locations of sensor blocks deployed in the workspace;
projecting the activation status list of sensor blocks onto the composite image of the workspace; and
in response to detecting the activation status list corresponding to the first unique identifier assigned to the first sensor block, annotating the first sensor block as activated within the composite image of the workspace.
